(19) United States
(12) Patent Application Publication
(10) Pub. No.: US 2016/0238395 A1
(43) Pub. Date: Aug. 18, 2016

(54) METHOD FOR INDOOR AND OUTDOOR POSITIONING AND PORTABLE DEVICE IMPLEMENTING SUCH A METHOD

(71) Applicant: COMMISSARIAT A L'ENERGIE ATOMIQUE ET AUX ENERGIES ALTERNATIVES, Paris (FR)

(72) Inventors: Mehdi BOUKALLEL, GIF SUR YVETTE (FR); Alexandre PATAROT, GIF SUR YVETTE (FR); Sylvie LAMY-PERBAL, GIF SUR YVETTE (FR)

(21) Appl. No.: 15/029,240

(22) PCT Filed: Oct. 13, 2014
(86) PCT No.: PCT/EP2014/071839

§ 371 Date: Apr. 13, 2016

(30) Foreign Application Priority Data
Oct. 24, 2013 (FR) 1360384

(51) Int. Cl. G01C 21/16; G01P 15/02; G01C 19/00

(52) U.S. Cl. CPC G01C 21/16; G01C 19/00; G01P 15/02

(57) ABSTRACT

A locating device equipping a mobile body, comprises an inertial platform, a 3D gyrometer and accelerometer, a calculation unit receiving measurements of the gyrometer and accelerometer a sampling frequency, and means to locate the mobile body, the calculation unit performing: a preliminary step where the mobile body travels a known trajectory, calculation of a coefficient of proportionality between distance actually traveled and raw distance obtained by integrating the time derivative of the acceleration along the trajectory; a following step of free displacement, location of the mobile body by dead-reckoning navigation procedure, being performed by using distance traveled the raw distance corrected by the proportionality coefficient. A model representing drift due to bias of measurements of angular velocities delivered by the gyrometer is calculated by a regression between measurements and orientation of the known trajectory, the measurements considered in the free displacement being measurements corrected by subtraction of the model.

The present invention relates to a method of indoor and outdoor location, and a portable device implementing such a method. It applies in respect of the location of pedestrians in indoor and outdoor environments. The invention applies particularly in respect of first-responders such as for example firemen or policemen, isolated workers or else people afflicted with visual or cognitive deficiencies.

Among all the families of locating systems, one distinguishes firstly those which do or do not depend on an infrastructure. Thus, radio systems, such as GPS and Wifi in particular, require transmitters whilst barometers, magnetometers and inertial sensors operate in an autonomous manner. Among those which do not require any infrastructure, there are those which depend on the environment, such as barometers for example, and those which do not depend thereon, such as gyrometers providing only a mechanical measurement. It is thereafter possible to refine the classification of these locating systems by their capacity for integration and their cost. For example, tactical inertial platforms integrated into airplanes or missiles are based on expensive but reliable optical gyrometers, whilst those onboard mobile terminals are low-cost but rather unreliable.

A technical problem to be solved is that of locating a pedestrian in a constrained environment, for example in a storey of a building or in a dense urban setting, with low-cost devices providing solely the measurements of acceleration and angular velocity, as well as the initial position of the user and a second position known either by this user, or by an external system. Moreover, it is necessary to be able to locate the user when moving around with good precision, of the order of a few meters for example. For indoor location, a difficulty arises when it is necessary to ensure such location while circumventing infrastructures deployed in the environment, such as beacons or antennas for example. To succeed in positioning the user, the locating device must be equipped with measurement sensors. It estimates the position relative to a departure point and delivers the position item of information to the user himself or to other entities, such as for example carried or remote viewing sets. Given that the user is moving around, the device must not be very bulky. A technical solution adopted must therefore minimize bulkiness related to the sensors.

Several location solutions are known, in particular indoor, without infrastructure.

Pedometer-based solutions rely on the measurement of the user's walking speed. On the basis of the measurement of the number of paces and of the pace length, an estimation of the distance traveled is made. However, if the length of the user's pace changes, passing for example from a fast walk to a slow walk, the solution can lead to poor estimation of the distance traveled and therefore of the location of the user.

Odometer-based solutions are widely used. The device then consists mainly of an inertial platform placed on the user's foot. Measurements of acceleration and of rate of rotation, allied with dead-reckoning techniques, make it possible to estimate the distance traveled by the user. A problem related to these solutions is the need for sizable calculation means to contain the sizable drift of inertial platforms. Moreover, siting the sensor on the foot complicates the implementation.

In these solutions, the sensors are located on the waist, on the wrist or on the arm. The estimation of the distance traveled is carried out on the basis of the measurement of the acceleration. However, these solutions often exhibit reduced performance compared with the “foot-mounted” solution, in particular because of the location of these sensors on the body where the dynamics is less opportune. They are not used alone but are in fact hybridized with other techniques to afford orientation information for example. Sizable calculation means are moreover necessary.

Other solutions use the measurement of the variation of the local terrestrial magnetic field to, for example, estimate the user's rate of advance. Such a measurement may on the one hand make it necessary to equip the user with a compass, but the device is then sensitive to the presence of objects which locally disturb the terrestrial magnetic field in the environment of the user, these objects possibly being for example furniture, metal frameworks or the electronic terminal itself. Moreover, the measurement may make it necessary to equip the user with a constellation of magnetic sensors so as to measure for example the spatial gradient of this magnetic field. But a drawback of this solution is the need to arrange the constellation of sensors in a precise manner and to calibrate it carefully.

Finally, it is also known to use visual solutions. The user is equipped with a camera which observes the field ahead. This solution commonly combines two steps, that of estimating the advancing of the mobile object on the basis of characteristic points of the environment and the recognition of characteristic points. The first step makes it possible to estimate the distance traveled and the second step makes it possible to carry out a charting of the position of the user with respect to an absolute frame of reference. A drawback of this solution is that it makes it necessary to orient the camera in the field of displacement of the mobile object. Moreover, because of the very principle of this technique, the camera is sensitive to lighting parameters and orientation parameters and to vibrations. Moreover, sizable calculation means are necessary to ensure location of the mobile object.

None of these solutions meets the objectives of producing a reliable and not very bulky handheld device, which is independent of the environment or of any infrastructure, allowing in particular:
Location with very small drift, for example less than 5% of the total distance traveled, in a closed or open environment, without pre-equipment of sites;
Small-size and easily transportable equipment, able to be fixed to the waist of a pedestrian for example;
Calculation which is economical in resources but which affords robust estimation of the user's position.

The aim of the invention is in particular to achieve these objectives. For this purpose, the subject of the invention is a method such as described by the claims.

The subject of the invention is also a device implementing such a method.

Other characteristics and advantages of the invention will become apparent with the aid of the description which follows, given in conjunction with appended drawings which represent:

FIG. 1, the possible components of a device according to the invention and the steps that they implement;

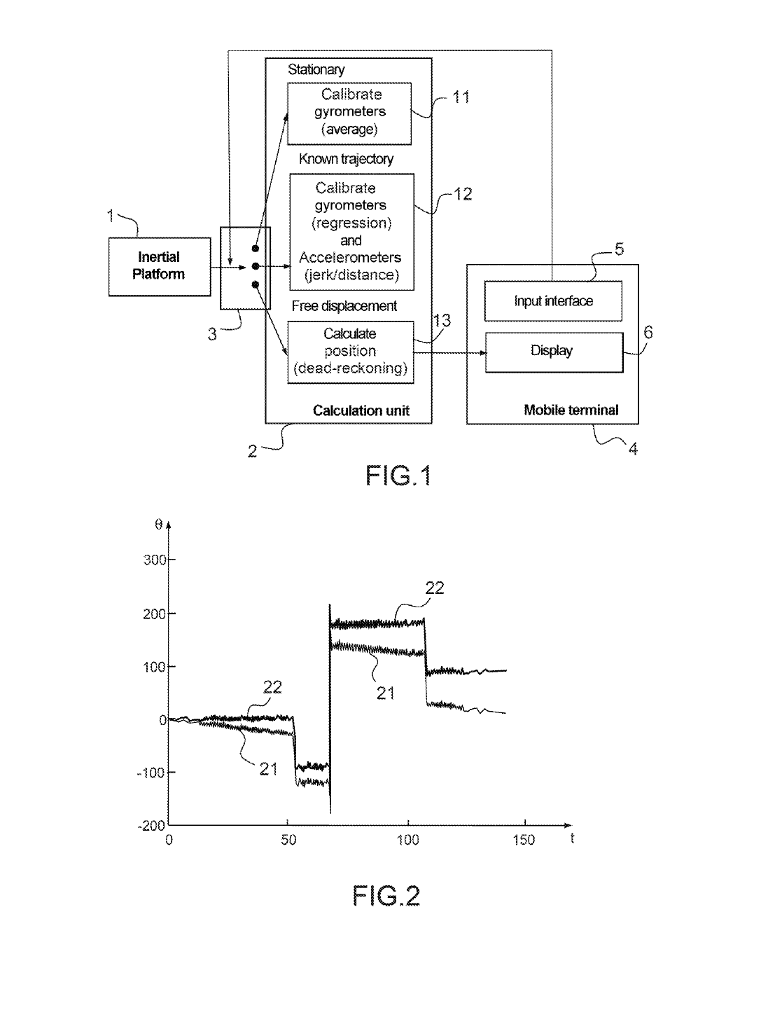

FIG. 2, the result of a correction of angular measurements by real-time affine regression;

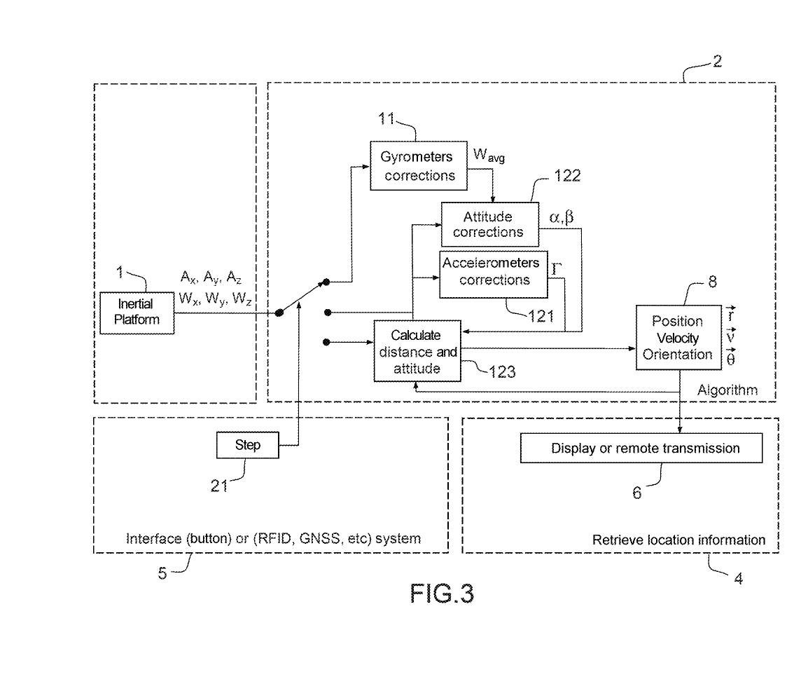

FIG. 3, a functional diagram of an exemplary device according to the invention;

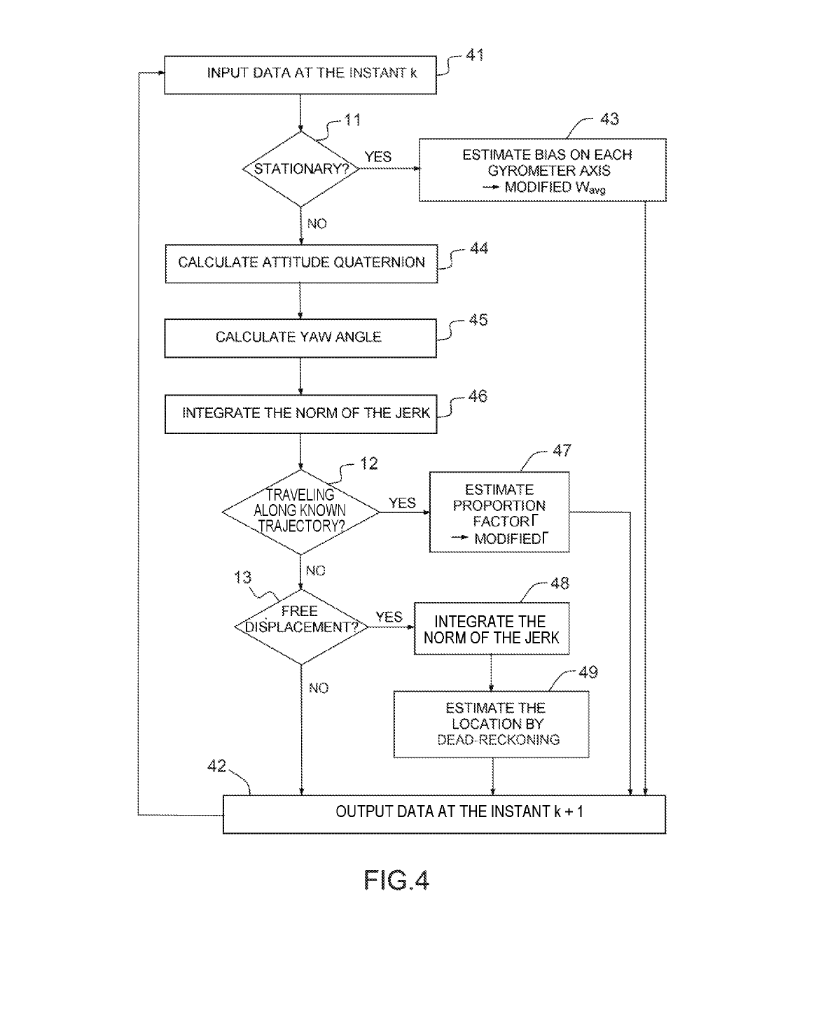

FIG. 4, an exemplary algorithm implementing the method according to the invention.

FIG. 1 presents the possible components of a device according to the invention and the steps that they implement. By way of example the invention is described for the location of a pedestrian, but it can also apply to the location of mobile bodies in motion.

The device comprises at least:

an inertial platform 1 capable of providing the accelerations of its center of inertia with respect to the terrestrial frame of reference, expressed in its 3D local reference frame, as well as the angular velocities expressed in this same local reference frame;

a calculation unit 2 able to receive digital data for example in matrix form with linear-algebra tools, in real time, and to provide as rapidly as possible the result of a calculation;

a digital processing unit 3 capable of providing the data arising from the inertial platform 1 to the calculation unit 2 and of recovering the results therefrom so as to write them for example in a file or on a communication port.

A mobile terminal 4 completes for example the assembly. This terminal comprises an input interface 5 able to provide the digital processing unit with location information known a priori, either by the user, or by an external system. For example, a button on the mobile terminal makes it possible to enter an item of information into the system. The display means 6 of the terminal make it possible to retrieve estimated location information. The screen of the mobile terminal makes it possible for example to display either a point on a map, or numerical values.

Among the solutions of the prior art, some of which have been briefly described hereinabove, it is suggested on the one hand to count the paces by detecting them with accelerations and to multiply by an average length of a pace to obtain a distance traveled, or, on the other hand, to integrate the accelerations according to each dimension so as to obtain a distance traveled. In the latter case, because of measurement errors, the estimated value drifts with time. This is a first problem. A solution also proposed in the prior art then consists in not aggregating the errors, in particular while planting the foot on the ground when the platform is stationary. However, this correction makes it necessary to place the inertial platform at foot level and thus creates an equipment constraint, thus constituting another problem. Finally, certain solutions are based on stochastic chartings such as particle filters, which often demand sizable calculational resources in order to utilize walking models or cartographic information for example, thus leading to a third problem. A device according to the invention solves in particular these three problems while using a dead-reckoning navigation procedure. This procedure consists in estimating a 2D position on the basis of the distance traveled and in projecting it according to the orientation (yaw) of the device over time. According to the invention, before commencing this dead-reckoning procedure, a preliminary phase of calibrations is performed.

The calibrations and the calculation of position are performed by the calculation unit 2. This unit implements three steps 11, 12, 13, the first two 11, 12 of which are two preliminary steps preceding the location by dead-reckoning properly speaking.

The first, static, step 11 is carried out whilst the carrier or wearer, and therefore the device, is stationary. The second, dynamic, step 12 is carried out on a known trajectory. Finally the third step 13 performs the location of the carrier or wearer by dead-reckoning whilst the latter performs a free displacement. The two preliminary steps 11, 12 make it possible to obtain coefficients correcting the calculations of distance and of attitude performed during the third step 13 of location during free displacement of the carrier or wearer, the distance and attitude calculations being used by the method of dead reckoning. As the subsequent description will show, these coefficients correct, in particular, the measurement biases of the sensors of the inertial platform.

The inertial platform 1 is therefore composed of two sensors, a 3D accelerometer and of a 3D gyrometer which respectively deliver the accelerations and the angular velocities. These sensors deliver for example measurements in relation to three axes, the accelerometer delivering the accelerations (Ax, Ay, Az) and the gyrometer delivering the angular velocities (Wx, Wy, Wz) of the mechanical reference frame tied to the inertial platform. The measurements originating from these two sensors are biased by a random systematic measurement constant and contain noise due to thermo-electronic effects for example. The invention handles the influence of the measurement biases without handling the noise which may if it is bothersome be handled by numerous known solutions.

The outputs of the gyrometers are biased. These biases can be estimated in the first preliminary step 11 whilst the carrier or wearer is stationary by calculating averages of measured angular velocities, whilst the angular velocity is ideally a zero vector. The calculated average gives an estimation of the bias.

However, in the majority of cases this first estimation of the bias does not suffice to precisely estimate the yaw drift estimated by integrating the angular velocities. According to the invention, a calibration is then performed on a known trajectory, for example on a rectilinear portion between a point A and a point B when the yaw is equal to the initial orientation, that is to say zero. The constant bias integrated with respect to time, while traveling along this portion A-B, creates a linear ramp whose coefficient may be estimated for example by affine regression and thereafter be subtracted from the estimated initial value. This calibration is performed during the second preliminary step 12.

FIG. 2 illustrates the result of the angular correction by affine regression in real time by two curves 21, 22 representing the angular value of the yaw with respect to time. A first curve 21 represents the yaw without correction where the linear drift a.t with respect to time is observed. A second curve 22 represents the yaw with the bias correction.

FIG. 2 illustrates a particular case where the measurements of the gyrometer are corrected by subtracting a ramp. This case can apply in particular when the known trajectory A-B is rectilinear. More generally according to the invention, the drift due to the measurement biases of the gyrometer is estimated by a model, based on linear regression for example, by estimating the coefficients of the straight line representing the linear drift as in the case of FIG. 2. Next the model is subtracted from the orientation estimation (yaw) resulting from the raw measurements of angular velocities given by the gyrometer. It is possible to use another type of regression to calculate a model of drift of the measurements of the gyrometer, in particular when the known trajectory is not rectilinear. Thus, a polynomial regression of higher order, or any other regression, can be used, the aim being to compare a model of the evolution of the yaw, arising from the known trajectory portion and impacted by the bias, with respect to the raw measurements.

The measurements of the accelerometers are also biased, in particular by the value of gravity which it is difficult to estimate in relation to each of the axes of the platform 1 since its 3D orientation is unknown. To eliminate the constants, that is to say the bias and gravity, the invention uses a quantity subsequently called “jerk” which is the time derivative of the acceleration, corresponding to the third derivative of the distance with respect to time. The jerk is defined by a three-dimensional vector:

dA/dt=(dAx/dt, dAy/dt, dAz/dt), A being the acceleration vector.

It is also possible to write Jₖ the jerk at an instant k, according to the following relation (1)

Jₖ=(Aₖ−Aₖ₋₁)dt,

Aₖ and Aₖ₋₁ being the acceleration vectors at the instants k and k−1.

Subsequently, according to the invention, to avoid aggregating the errors attributable to the gyrometer during the change of reference frames of the acceleration vector, the norm of the jerk is advantageously used since it is invariant under a change of reference frame. This change of reference frame corresponds here to passing from the reference frame of the inertial platform strapped to the carrier or wearer to the navigation reference frame attached to the Earth or to the building within which the carrier or wearer is moving. Advantageously, the use of the norm of the jerk avoids the errors of projection on the reference frame the new reference frame.

The norm of the jerk is thus integrated with respect to time, thrice, to obtain the aggregate distance traveled. However, the directly obtained integrated value does not correspond to the aggregate distance but to a proportional value. In order to obtain the coefficient of proportionality between the integrations of the jerk and the actual aggregate distance, it is necessary to ascertain the distance traveled over a known trajectory portion, for example over the portion A-B described hereinabove. This coefficient is obtained in the previously mentioned second preliminary step 12.

FIG. 3 presents a functional diagram of a device according to the invention. The data provided by the inertial platform, that is to say the data of the accelerometer (Ax, Ay, Az) and the data of the gyrometer (Wx, Wy, Wz), are transmitted to the calculation unit 2. These data are for example transmitted at a frequency of the order of 100 Hz. The calculation unit must be capable of managing operations in real time, at least as quickly as the frequency of arrival of the inertial data, i.e. about 100 Hz.

The calculation unit implements the three steps 11, 12, 13 described previously. An exterior item of information 21 signals to the calculation unit which step it should apply, in particular the calculation unit must know whether the carrier or wearer is stationary for the first step 11, whether same is traveling along the known portion for the second step 12 or whether same is in free displacement 13.

This exterior item of information 21 can be activated in various ways. It can be provided by an input device of the button type or an external locating system, for example of the GPS or RFID tag reader type, on condition that these location items of information are available. The item of information can therefore be given by the user, via a button or any interface, with for example the following indications on a screen: “I am stationary” for the first step 11, “I am walking between A and B” for the second step 12 and “Locate me” for the third step 13 during free displacement. These situations can also be detected by means of external location which dispatch the item of information to the calculation unit.

In the first step 11, whilst the carrier or wearer is stationary, the device calculates the average of the angular velocities on the basis of the inertial data (Wx, Wy, Wz), so as to access the biases at the output of the gyrometers. The biases in relation to the three axes are obtained by comparing the average with the ideal case in which these outputs are zero. Indeed, in an ideal case without bias, and a stationary carrier or wearer, these inertial data are zero. The user remains for example stationary for 10 seconds so as to utilize a significant number of samples, 1000 if the sampling frequency is 100 Hz. At the end of this first step 11, a three-dimensional mean vector Wavg is accessed, containing the average of the angular velocities on each axis. The calculation of these average values is for example recursive during this first step. This estimation of the bias is preserved in memory and utilized in the following steps for the orientation calculation and the angular corrections.

In the second step 12, traveling along the known trajectory between a point A and a point B makes it possible to obtain on the one hand the coefficient of proportionality Γ between the aggregate distance obtained by integrating the jerk and the actual distance traveled, and on the other hand the coefficients α and β of the straight line representing the angular drift of the yaw.

The coefficient of proportionality Γ between the integration of the norm of the jerk and the actual distance is obtained, 121, on account of the fact that at the end of the trajectory the distance between the points A and B is known. This coefficient is in particular given by the ratio ABᵢₙₜ/AB_{actual} where ABᵢₙₜ is the integration of the jerk and AB_{actual} is the known actual distance. As indicated previously, the integration of the jerk is a triple integration with respect to time, given that the jerk is the time derivative of the acceleration given by the accelerometer of the inertial platform. In fact this entails three integrations, along the three axes, of the quantities dAx/dt, dAy/dt and dAz/dt. Ax, Ay and Az are the accelerations along the three axes. According to the invention, this time derivative of the acceleration vector is advantageously used since it makes it possible to eliminate the biases, assumed to be constant. Moreover, the norm of the vector is advantageously used since it is invariant, that is to say it does not depend on the reference frame considered. Errors of projection of the accelerations measured in the reference frame tied to the inertial platform to the navigation reference frame in which the carrier or wearer is located are thus avoided.

Moreover, the known trajectory A-B makes it possible, if it is rectilinear for example, to know the orientation of the carrier or wearer which is the same orientation as the initial orientation. The points A and B can be signaled by the user or by an external system of the RFID or GNSS type for example, or any other locating system. An exemplary pinpointing of this known trajectory can be done with the aid of two boundary markers linked by a wire of known length. To carry out the second step 12, the first boundary marker, signaling the point A, is therefore put down at a place, and then the wire is stretched for example in a straight line so as to plant the second boundary marker, signaling the point B. In a case where the wire measures 30 meters, there is thus a rectilinear trajectory of 30 meters between the two boundary markers A, B. The calculation unit then receives the item of information that the user is traveling along the trajectory between A and B, either by the user himself via the aforementioned interface, or by external location means.

As shown in FIG. 2, the yaw is ideally zero on the rectilinear trajectory portion. FIG. 2 also shows that the bias, assumed constant, in the angular velocities causes the attitude to drift in a linear manner with respect to time. An affine regression then makes it possible to estimate the coefficients α and β of the straight line (y=α.t+β) representing this drift. This improves the estimation of the bias and makes it possible to correct the yaw, that is to say the attitude, over time.

To perform the corrections, the attitude and the distance traveled must be estimated from this dynamic step 12 onwards. The attitude is calculated by integrating the angular velocities, via an integration of quaternions. Quaternions are a linear algebra tool which is easy to implement in a calculation unit. They exhibit the advantage of avoiding singularity problems, such as Euler angles and gimbal lock in particular. That is to say, the calculation is effective and accurate whatever the orientation, this not being the case with other procedures. The distance is calculated by several integrations of the norm of the jerk and with the proportionality factor.

At this juncture, the system is not yet operational for navigating by dead reckoning. It is only once the coefficients Γ, α and β have been estimated that the inertial raw measurements will be able to be utilized 123 while minimizing the impact of the biases.

After the previous two steps 11, 12, the system is operational for commencing the third step of location 13, during free displacement. The calculations of distance and of attitude are corrected by the coefficients arising from the static calibration (stationarity) and from the dynamic calibration (rectilinear known trajectory) to provide in two dimensions a position, a velocity and an orientation. This step is based on the well-known procedure of dead reckoning.

In this step, navigation is thus based on the dead reckoning technique and relies on an attitude estimation by integration of quaternions and on a distance estimation by integration of the norm of the jerk. The device according to the invention uses the known method of dead reckoning but uses to perform the location according to this method the distance information and yaw information obtained respectively by integrating the norm of the jerk, corrected for the proportionality coefficient, and by integrating the angular velocities obtained via the quaternions and corrected by the linear regression.

FIG. 4 summarizes the possible manner of operation of a device according to the invention and in particular the algorithm executed by the calculation unit 2. FIG. 4 illustrates the flow of the steps and the recursive calculations inside each step. This algorithm implements steps 11, 12, 13 described previously. The algorithm is looped between two samplings, for example at the frequency 100 Hz. The input data 41 at the instant k pass the various steps of the algorithm. The output data 42 supplement the input data at the following instant k+1.

The input data comprise five groups of data:
The calibration data (calculated during the preliminary steps 11, 12);
The measurements data provided by the sensors of the inertial platform and provided continually, for all steps 11, 12, 13;
The external system or user inputs indicating which step the user is in;
The estimations of the previous calculation loop;
The constants.

The input data at an instant k which are used, in addition to those above, during the calibration steps are as follows:
the coarse estimation of the biases in the angular velocities Wavg,k (which is calculated during the first step 11);
the fine estimation of the angular velocity biases through the coefficients α,k and β,k (which are calculated during the second step 12);
the coefficient of proportionality Γ between raw distance and actual distance (which is calculated during step 12)

The measurements data are on the one hand the acceleration vectors A,k−1at the instant k−1 and the acceleration vector A,k at the instant k, the calculation of the jerk at the instant k being calculated on the basis of these two values (see relation (1) hereinabove) and on the other hand the angular velocity vector W,k.

The user or system inputs arise from the external item of information: stationary, travel along the known trajectory or free displacement.

The previous estimations are the position in two dimensions (2D) R,k which is calculated in the free displacement phase 13, the attitude quaternion Q,k calculated on the basis of the second step 12 and the raw distance D,k over the known trajectory portion also calculated on the basis of this second step. The raw distance is the aggregate distance calculated by integration of the jerk before correction by the proportionality coefficient.

The constants are the real distance AB_{actual} and the sampling frequency, 100 Hz for example.

The data on output from an algorithm loop are the calibration data and the estimation data.

It is thus possible to follow the course of the algorithm of FIG. 4, executed by the calculation unit 2.

As long as the exterior item of information indicates that the carrier or wearer is in a stationary position (first step 13), the calculation unit performs the estimation 43 of the bias by calculating the average angular velocity vector Wavg constituting the coarse estimation of the biases in the angular velocities, in relation to the three axes. The modified average value will be an input datum at the instant k+1. It is calculated by recursivity, that is to say:

Wavg,k=(k/k+1)Wavg,k−1+(1/k+1)W,k

Wavg,k and Wavg,k−1 being respectively the mean vector calculated at the instants k and k−1 and W,k the measurement of the angular velocity at the instant k.

The recursivity makes it possible to save calculation memory and to be compatible with a real-time calculation executed between two successive samples. The mean vector Wavg obtained at the end of the step will in particular be used in the second step to integrate the attitude quaternion without measurement bias.

As soon as the user commences traveling along the known trajectory, that is to say when he is no longer stationary, the calculation unit successively performs the calculation 44 of the attitude quaternion, the calculation 45 of the angle of yaw by the previously described affine regression giving the orientation of the user, and the integration 46 of the norm of the jerk.

As long as the user is traveling along the known trajectory (second step 12), the calculation unit performs 47 the estimation of the proportionality factor Γ which becomes an output datum. This coefficient being calculated in a recursive manner, it can be obtained in the following way:

Γ,k=Γ,k−1+δd,k/AB_{actual}

Γ,k and Γ,k−1 being the proportionality coefficient respectively at the instants k and k−1.

δd,k is the integration of the jerk Jk between the instants k−1 and k, that is to say the raw distance traveled, i.e.:

δd,k=(dt³/3)∥Jk∥ (2)

dt is the inverse of the sampling frequency F (dt=1/F), and corresponds to the time interval between the instants k−1 and k.

As soon as the user has finished traveling along the known trajectory and commences the free displacement 13, the calculation unit performs 48 the integration of the jerk in the same manner as in the second 12, according to relation (2) hereinabove. The actual distance δd,k_{actual} traveled between two sampling instants k−1 and k is calculated by multiplying this integration by the coefficient Γ obtained at the end of the second step 12.

The actual distance traveled is obtained by recursivity, the actual distance d,k+1 traveled at the instant k+1 being obtained on the basis of the actual distance d,k traveled at the instant k in the following way:

d,k=d,k+1+Γ×δd,k

On the basis of the calculated actual distance, the calculation unit determines the user's location according to the dead reckoning procedure.

The algorithm of FIG. 4 is a possible mode of implementation of steps 11, 12, 13. Other modes of implementation are possible. In particular in the first step 11, the angular velocity Wavg can be calculated by a non-recursive procedure. The same holds in the second step 12 for the calculations of the coefficient Γ so as to deduce the actual distance on the basis of the integration of the norm of the jerk, and of α and β making it possible to calculate the angle of the yaw. Optionally the first step 11 might not be implemented according to the precision that is desired for the calculation of the attitude.

The compensations of the biases make it possible to solve the temporal drift problem. Moreover, these compensations do not in any case involve detection of paces, thereby making it possible to circumvent the assumptions of planting the foot on the ground and therefore of the periodic stationarity of the platform. Thus, the platform may be placed at waist level, or even elsewhere on the user's body.

Finally the invention is compatible with the constraints of real time and of moderate use of the memory by virtue of the recursivity since each state (position, ttitude, coefficient of proportionality Γ between the norm of the jerk and the distance, affine regression coefficients α and β) can be estimated on the basis of its value at the previous instant. Moreover, only the raw inertial data, with no pseudo-measurement of pace detection type, are utilized, thereby lightening the calculation.

A device according to the invention is therefore easy to carry or wear. It comprises an inertial platform, calculation means and display means, a screen for example, in particular to retrieve the position by displaying a point on a map. It can also comprise means for transmitting the location data to a remote server.

The choice of a gyrometer is particularly judicious since the orientation estimations do not depend on the exterior environment as in the case of magnetometers used in systems according to the prior art.

It is possible to add a mapping of the sites where the user is moving, and this may improve his guidance on the basis of the location data. To reduce the impact of white noise on the measurements, it is possible to use a Kalman filter for example.

The method implemented by the invention, in particular the algorithm executed by the calculation unit 2, allows real-time location with restricted calculation resources with a result similar to those of the devices of the prior art in terms of precision, or indeed better. The hardware required is low-cost and the sensors used, gyrometer and accelerometer, can be miniature. This hardware is also easily integratable into already marketed technologies, for example mobile telephones.

The equipment can be installed rapidly on the user. It is not very bulky and can equip all types of pedestrians. The device can operate alone or be hybridized with another locating system.

In an embodiment with a mobile terminal 4 containing the input interface 4 and the display 6, this terminal can advantageously be a mobile terminal of smartphone type. In this case, the calculation unit 2 can be linked to a communication port allowing it to communicate with the mobile terminal through a wireless link, of Wifi or Bluetooth type, optionally by wired link. Advantageously, the wireless communication can be done according to the http standard protocol, allowing interfacing with all types of mobile terminals having a Web browser. The user can then enter his instructions on the terminal and read the display of the location results on this same terminal.

The invention has been described for locating a pedestrian. It can also apply for locating a person moving around in a wheelchair. More generally, it can apply for locating mobile bodies such as wheeled or caterpillar track vehicles, carts, or else terrestrial or aerial drones.

1. A method for locating a mobile body, wherein, said mobile body being equipped with at least one inertial platform comprising a 3D gyrometer and a 3D accelerometer, said method comprises:
a preliminary step wherein, said mobile body traveling along a known trajectory, a coefficient of proportionality between the known distance actually traveled and the raw distance obtained by integrating the norm of the time derivative of the acceleration over said trajectory is calculated;
a following step of free displacement wherein the location of said mobile body is performed by the dead-reckoning navigation procedure, the location being performed by using as distance traveled the raw distance obtained by integrating the norm of the time derivative of the acceleration corrected by the proportionality coefficient.

2. The method as claimed in claim 1, wherein in the preliminary step, a model is calculated representing the drift due to the measurement bias of angular velocities delivered by the gyrometer by a regression between said measurements and the orientation on said known trajectory, the measurements taken into account in the free displacement step being said measurements corrected by subtraction of said model.

3. The method as claimed in claim 2, wherein, the trajectory being rectilinear, said model is obtained by linear regression between said measurements and the orientation of said known trajectory.

4. A method for locating a mobile body, wherein, said mobile body being equipped with at least one inertial platform comprising a 3D gyrometer and a 3D accelerometer, said method comprises:
a preliminary step wherein, said mobile body traveling along a known trajectory, a model is calculated representing the drift due to the measurement bias of angular velocities delivered by the gyrometer by a regression between said measurements and the orientation of said known trajectory;
a following step of free displacement wherein the location of said mobile body is performed by the dead-reckoning navigation procedure, the location being performed by using said measurements, corrected by subtraction of said model.

5. The method as claimed in claim 4, wherein, the trajectory being rectilinear, said model is obtained by linear regression between said measurements and said trajectory.

6. The method as claimed in claim 4, wherein in the preliminary step, a coefficient of proportionality between the known distance actually traveled and the raw distance obtained by integrating the norm of the time derivative of the acceleration over said trajectory is calculated, the location being performed in the free displacement step by using as distance traveled the raw distance obtained by integrating the norm of the time derivative of the acceleration corrected by the proportionality coefficient.

7. The method as claimed in claim 1, comprising a first preliminary step wherein, said mobile body being stationary, the average values of the angular velocity measured in relation to the three axes of the gyrometer are calculated, said average values forming a first estimation of the gyrometer measurement biases.

8. A locating device able to equip a mobile body, wherein said device comprises at least one inertial platform comprising a 3D gyrometer and a 3D accelerometer, a calculation unit receiving the results of measurements of the gyrometer and of the accelerometer according to a sampling frequency, and means of retrieval of location of said mobile body, the calculation unit performing:
in a preliminary step where said mobile body travels a known trajectory, the calculation of a coefficient of proportionality between the distance actually traveled and the raw distance obtained by integrating the time derivative of the acceleration along said trajectory;
in a following step of free displacement, the location of said mobile body by the dead-reckoning navigation procedure, the location being performed by using as distance traveled the raw distance obtained by integrating the time derivative of the acceleration corrected by the proportionality coefficient.

9. The device as claimed in claim 8, wherein in the preliminary step, the calculation unit calculates a model representing the drift due to the bias measurements of the delivered by the gyrometer by a regression between said measurements and the orientation of said known trajectory, the measurements taken into account in the free displacement step being said measurements corrected by subtraction of said model.

10. The device as claimed in claim 9, wherein, the trajectory being rectilinear, said model is obtained by linear regression between said measurements and said trajectory.

11. A locating device able to equip a mobile body, wherein said device comprises at least one inertial platform comprising a 3D gyrometer and a 3D accelerometer, a calculation unit receiving the results of measurements of the gyrometer and of the accelerometer according to a sampling frequency, and means of retrieval of location of said mobile body, the calculation unit performing:
in a preliminary step where said mobile body travels a known trajectory, the calculation of a model representing the drift due to the measurement bias of angular velocities delivered by the gyrometer by a regression between said measurements and the orientation of said known trajectory;
in a following step of free displacement, the location of said mobile body by the dead-reckoning navigation procedure, the location being performed by using said measurements, corrected by subtraction of said model.

12. The device as claimed in claim 11, wherein, said trajectory being rectilinear, said model is obtained by linear regression between said measurements and said trajectory.

13. The device as claimed in claim 11, wherein in the preliminary step, the calculation unit performs the calculation of a coefficient of proportionality between the known distance actually traveled and the raw distance obtained by integrating the norm of the time derivative of the acceleration over said trajectory, the location being performed in the free displacement step by using as distance traveled the raw distance obtained by integrating the norm of the time derivative of the acceleration corrected by the proportionality coefficient.

14. The device as claimed in claim 8, wherein it performs a first preliminary step wherein, said mobile body being stationary, the calculation unit calculates the average values of the angular velocity measured in relation to the three axes of the gyrometer, said average values forming a first estimation of the gyrometer measurement biases.

15. The device as claimed in claim 8, wherein the calculation unit estimates the attitude by integration of quaternions, said attitude being used by the dead-reckoning navigation procedure.

16. The device as claimed in claim 8, wherein the calculation unit communicates with an input interface receiving an exterior signal informing the calculation unit to engage a following step.

17. The device as claimed in claim 16, wherein said exterior signal is activated by said mobile body.

18. The device as claimed in claim 16, wherein said exterior signal is activated by an external locating system.

19. The device as claimed in claim 16, wherein, the gyrometer and the accelerometer delivering the results of measurements according to a given sampling frequency, the calculation unit carries out the first preliminary step, the step of traveling over a known trajectory and the free displacement step in a recursive manner at the speed of said sampling frequency, said steps being triggered successively by said exterior signal.

20. The device as claimed in claim 11, wherein as long as the exterior signal indicates that said mobile body is stationary the calculation unit performs the estimation of the bias by calculating the average angular velocity vector constituting the estimation of the biases in the angular velocities, in relation to the three axes, the average value being calculated by recursivity, so that:
Wavg,k=(k/k+1)Wavg,k−1+(1/k+1)W,k
Wavg,k and Wavg,k−1 being respectively the mean vector calculated at the sampling instants k and k−1 and W,k being the measurement of the angular velocity at the instant k.

21. The device as claimed in claim 13, wherein as long as the exterior signal indicates that said mobile body is stationary the calculation unit performs the estimation of the bias by calculating the average angular velocity vector constituting the estimation of the biases in the angular velocities, in relation to the three axes, the average value being calculated by recursivity, so that:
Wavg,k=(k/k+1)Wavg,k−1+(1/k+1)W,k
Wavg,k and Wavg,k−1 being respectively the mean vector calculated at the sampling instants k and k−1 and W,k being the measurement of the angular velocity at the instant k;
as long as the exterior signal indicates that said mobile body is continuing to travel the known trajectory, the calculation unit performs the estimation of the proportionality factor Γ, this coefficient being calculated in a recursive manner, so that:
Γ,k =Γ,k−1+δd,k/AB_{actual}
Γ,k and Γ,k−1 being the proportionality coefficient respectively at the sampling instants k and k−1 and δd,k being the integration of the norm of the time derivative of the acceleration between the instants k−1 and k.

22. The device as claimed in claim 13, wherein as long as the exterior signal indicates that said mobile body is stationary the calculation unit performs the estimation of the bias by calculating the average angular velocity vector constituting the estimation of the biases in the angular velocities, in relation to the three axes, the average value being calculated by recursivity, so that:
Wavg,k=(k/k+1)Wavg,k−1+(1/k+1)W,k
Wavg,k and Wavg,k−1 being respectively the mean vector calculated at the sampling instants k and k−1 and W,k being the measurement of the angular velocity at the instant k;
in the free displacement step, the actual distance traveled being obtained by recursivity, the actual distance d,k+1 traveled at the sampling instant k+1 is obtained on the basis of the actual distance d,k traveled at the sampling instant k in the following manner:
d,k=d,k+1+Γ×δd,k
where Γ is the proportionality coefficient calculated in the step of traveling over a known trajectory and δd,k is the integration of the norm of the time derivative of the acceleration between the instants k−1 and k.

23. The device as claimed in claim 8, wherein a mobile terminal comprises the retrieval means and the input interface, said terminal communicating with the calculation unit via a wireless link according to an exchange protocol based on the http standard protocol.

24. The device as claimed in claim 8, wherein it is able to be worn or carried at the level of a person's waist.
